(19) United States
(12) Patent Application Publication
(10) Pub. No.: US 2020/0027052 A1
(43) Pub. Date: Jan. 23, 2020

(54) MACHINE LEARNING ASSISTED WORKFLOW PLANNER AND JOB EVALUATOR WITH LEARNING AND MICRO ACCREDITATION PATHWAYS

(71) Applicant: APPEARITION PRIVATE LIMITED, Melbourne (AU)

(72) Inventor: Vivek AIYER, Melbourne (AU)

(21) Appl. No.: 16/514,456

(22) Filed: Jul. 17, 2019

(30) Foreign Application Priority Data
Jul. 17, 2018 (IN) 201841026590

(51) Int. Cl. G06Q 10/06; G06N 20/00

(52) U.S. Cl. CPC G06Q 10/063112; G06Q 10/063116; G06N 20/00

(57) ABSTRACT

A system for generating automatic workflows, provisioning learning and skilling pathways based on dynamically evaluating the proficiency level of practitioners of any skill set, and producing specific documentation and job information supported by Machine Learning (ML) methodologies and human interaction, extending to the integration of IoT and the mining of unstructured data networks to efficiently address the requirements of job outcomes.

This application claims benefit of Serial No. 201841026590, filed 17 Jul. 2018 in India and which application is incorporated herein by reference. To the extent appropriate, a claim of priority is made to the above disclosed application.

### BACKGROUND

### Technical Field

The present invention relates to a system for generating personalized job workflows, provisioning gamified learning and skilling pathways discerned by a combination of machine learning modules (ML) and human intervention. This system is coordinated by event driven algorithms accepting live communiques, notification and alerts, to which data streams include Internet of Things (IoT) meshes, alongside other data sources, which are extended to also assist in the proficiency appraisal of workers whilst they conduct the necessary set of tasks to complete specific job requirements within explicit quantity, quality, costs and timely contexts. Such jobs are allocated by the system alongside documentation, learning and task specific material, including augmented reality overlays. Job selection, prioritisation and task documentation packaging, are continuously analysed to instigate new learnings that can be quantified and certified by the system network, which includes human intervention, as each assigned candidate progresses from one job to the next, with at a minimum, improved enterprise generated and accepted job performance scoring, leading at some point to gaining extendable micro awards.

### Description of the Related Art

There is a vast array of learning systems which prescribe to the definition of comprising of a “software application for the administration, documentation, tracking, reporting and delivery of educational courses or training programs” (https://en.wikipedia.org/wiki/Learning_management_system). There is also a multitude of systems that manage operational workflows by “setting up and monitoring a defined set of tasks along with its sequence” (https://www.techopedia.com/definition/30652/workflow-management-software).

Prior Art is lacking in providing a solution that combines learning on the job with a personalized approach that assigns individuals their own learning paths as discerned from their professional or technical history, their intents for their career, and the job performance requirements of individual organisations. The situation is further complicated by prior Art insisting on role-based workflows assuming a specific level of knowledge and adroitness about a process, without integrating the means to evaluate the impact that location and task variations have on that process, other than as ad hoc exceptions noted by administrator when time permits. Job performance assessment using prior Art examples tend to focus on the outputs, not the process as measure of success. This approach is heavily reliant on accessing already mature professional or technical resources, with the danger that job candidate pools stagnate as new talent is not provided with valid on the job learning opportunities. Prior Art also fails in providing a medium on which mundane tasks such as data analysis and correlations are delegated to machine processes automatically and the most valid use of human resources, mentoring and communication, is omitted in key areas of learning, such as task feedback and task support.

Accordingly, there is a need for a system to provide a machine learning assisted workflow planner and job evaluator which includes learning and micro accreditation pathways, that is a accreditation that is, at the very least, acceptable to the enterprise provisioning them to evidence specific learning or skills in a specific area for the purpose of further training and/or career advancement, that addresses or at least ameliorates one or more of the aforementioned problems of the prior art and/or provides customers a useful or commercial choice.

### SUMMARY

Generally, embodiments of the present invention relate to the issuance of a machine learning assisted workflow planner and job evaluator system, which includes learning and micro accreditation pathways generated and coordinated by event driven algorithms and human intervention at critical junctions.

Further, the system is provided for generating automatic workflows, provisioning learning, and skilling pathways, based on dynamically evaluating the proficiency level of practitioners of basic to higher skill levels, and producing specific documentation and job information based on data mining and Machine Learning (ML) methodologies to more efficiently address the requirements of job outcomes. The labels “job candidate”, “novice”, “practitioner”, and “user” will be used interchangeably in this document but understood to be the client users of the system services.

The concept of gamifying on-site learning relates to refocusing the learning experience as a game concept, where there exists a quest (the completion of a series of tasks), with barriers (any number of issues, from individuals lacking necessary experience, to the work-place being drastically different to expectations built by past learnings on other sites, etc), and allies that can be brought it to play under more complex situations. Besides just completing the work, the novice must collect evidence of their performance and present it to the cohort for evaluation to determine if a micro-award has been earned. Given this scenario it is evident that the system described in this document fulfils gaming fundamentals.

The use of Internet of Things (IoT) as a data rich live mesh which broadcasts data that can be mined for the purposes of live action monitoring, the building of data lakes to base predictive models, and constructing contextual information is no longer a new concept. However, enterprise tools are yet to fully capitalize on the possibilities. A new opportunity includes designing a system that has the capability to mine IoT meshes, transforming data lakes into contextual information that can be used to measure the levels of success, gauge potential for improvement and weigh risks associated with the workflows that drive industry. Its transformative potential includes the potential to provide dynamic proficiency evaluation as workers complete critical tasks as the system provides them with in-situ learning opportunities generated by the workflow itself, as it accommodates its tasks to respond to individual's skill level.

The human element is not lost in the prescription of this system, as it is a centre piece of its success. Workers utilizing the system will have access to a network that provides information to the cohort, a group of mentors, supervisors and matter experts, about the successes of the group. Workers will have the opportunity to learn new processes and tasks and be awarded the recognition they deserve for the new skill gained, by proceeding through a system assisted peer group assessment system. As the worker progresses through a new job/process or task, they will be guided by a system generated formative assessed workflow specific to their skill or knowledge level. At the completion of the job/process or task, the evidence that was gathered by the system as it progressed from diagnostic, maintenance or corrective routines (that is, by the user responding to prompts to: carry out and document site safety inspections; take snapshot or video of specific site or equipment at key points; carry out sensor readings from the IoT devices; read or accept AR information to assist in the progression of the work; etc) will be summarized in a report accessible by the job evaluation cohort (one nominated by the candidate and deemed by the system to possess the expertise to assess specific job or task outcomes). This evaluation cohort may vote on their level of agreement with the system generated score for the skill or skills demonstrated by the candidate. This human scoring and commentary on the evaluation process becomes another important input into the proficiency evaluation engine which continuously fine tunes its results, via ML recommendation, or collaborative filtering, systems. The candidate at the end of process may be awarded with a micro-badge that certifies to his cohort that the candidate has reached a new level of expertise.

According to one aspect, although not necessarily the broadest aspect, the present invention resides in a machine learning assisted workflow planner and job evaluator system, the system comprising:

An online computing platform hereby referred by its shorter descriptor as the computing platform, accessible by at least one administrator and/or user, but including various other roles as determined by its context, the administrator managing the selection and creation of digital material delivery channels, including all modern forms of digital representations;

At least one apparatus having a client application coupled to be in communication with the computing platform via a communications network relying on its proprietary application management interface (API) and client software development kit (SDK).

The apparatus includes computer readable program code components configured to enable the user accessing the client application to download one or more media items to a local storage system upon interrogation of a database residing in the computing platform.

The system comprises various system layers, which logically include:

A Data Lake, comprising of a storage of enterprise related records and digital media, residing within a structured format, that is, data that exists as a fixed field within a record or file; and unstructured formats, that is, data that exists without pre-defined data models or is not organized in a pre-defined manner.

A Data Access Application Programming Interface (API) that controls access to records or data, including machine generated data, in the Data Lake.

An Administration Portal (Administrator Portal), serviced by the appropriate technology (that is web-service, with or without html or native mobile interface, without impact to the critical description of the system), that provides a view to the tools and functions an administrator would presume to be accessible to manage the basics of this system.

An Extract Transform and Loading (ETL) system that transforms and stages records to provision Machine Learning (ML) and Central Processing Services as appropriate.

A Machine Learning (ML) layer that is used for training, evaluating and developing prediction models to be used in accordance with the requirements of the system.

A Central Processing system that co-ordinates the different layers into the necessary actions depending on the functionality required.

Computer readable program code components to configure a Correction Notification Alarm and Job Scheduler. This sub-system polls for active jobs set up by the job scheduler as well as searching for any alarms that signify that corrections to one of more components are required due to a fault. This collection of components collects, filters and priorities job notifications according to already set up business rules and displays the results in a job notification/alarms notification board accessible by the administrators, or others with appropriate permission.

Computer readable program code components that act as the JOB/Candidate Selection mechanism which produces a list of candidates, with and without learning modules and appropriate mentors (assigned from cohorts), depending on their system evaluated proficiency, provisioned with customised job packs to meet their individual requirements as per their defined knowledge and skillset. The system is also in charge of notifying and receiving responses from appropriate parties (administrator, cohort and candidates) on the selection process as relevant to their purposes.

Computer readable program code components that administer the Job Acceptance and Rejection process which prepares a job proposal package for the candidate to accept or reject. The system collects necessary information from the candidate on rejected submissions, as well as on acceptance, to produce new data that can be used by ML processes to adjust the impacted system profiles, as well as reports that may point at issues or improvements to be made.

Computer readable program code components that administers the Poll User Location process which is charged with matching the location of the user with the specific task or tasks that should be performed at such locations. Simultaneous Localization and Mapping (SLAM) and Visual Inertia Odometry (VIO) may be used by the system, as configured by the administrator on initialisation of the app, to provide the client device with a more accurate sense of the space and user location within it, along with pinpointing critical equipment to which tasks may be attached. The chaining of the job pack, that is which tasks and information appears first, may be sequenced by location as well as user input, or a combination of both.

Computer readable program code components that administers the option to render certain aspects of the job pack as augmented reality experiences or not, to which the client device provides the activation and rendering support, provided the user selects this service.

Computer readable program code components that administers the option to activate the Cohort Support System, which is charged with administering system registered communication between a novice and their mentor; the mentor's expert opinion on performance by the novice post job completion; and the novice's perception of the selected mentor (as a rapport score). These ratings are serialised for further processing by ML processes.

Preferably, the system issues a unique client token upon selection of a specific client app which is used to authenticate all Application Programming Interface (application programming interface) calls to the computing platform and ensure that only valid applications are accessing the system.

Preferably, the system comprises a client app configuration page which enables the administrator to select distinct client apps via a client app selection page.

Preferably, selection of a specific client app system elicits the creation of a new computing platform channel and application programming interface application token, the channel being required to isolate records from other client applications.

Preferably, upon authentication of the client application, the client application will download one or more computing platform experience packages that are either not present in a local storage system or have been modified by the content management system portal but not yet downloaded by the client application.

Preferably, an appropriate connection layer to handle external sources of information is selected as a result of the system accessing the specific external data clouds and IoT meshes, wherein the logic layer of the client application contains all the necessary data and client specific application programming interface preparation flows to satisfy the requirements of using the specific service chosen.

Suitably, at least one alert is issued to a user and/or administrator in the event that there is an internet connectivity or downloading issue.

Preferably, at least one request and at least one response issued by the system is in JSON format.

In one embodiment, the system comprises a cloud storage unit, also referenced as a data lake, that comprises workflow documentations, learning materials, photos and videos/sound files, or any such digital media, with metadata that are relevant to learning materials and any other digital materials.

In another embodiment, the data mining algorithm and ML process determines a level of expertise of cohorts, including their rapport with novices, in a given network, wherein the cohort is nominated by said system as including specific individuals with areas of expertise to which new learners can subscribe through said system network.

In yet another embodiment, the system comprises a system managed learning review mechanism to support and evidence learning on said job. The system managed learning review mechanism utilises a network of assigned mentors, previously recommended by the system and conferred as mentors by the candidate for scheduling automated notifications related to key processes, activities, and learning milestones that should be completed by the candidate. The system managed learning review mechanism injects a dictionary of administrator designed sentences that marshal the notification process to produce sufficiently clear instructions to each group, mentors and job candidates, about activities that must be carried out by mentors and candidates respectively to complete the learning review process.

In yet another embodiment, the system receives feedback from expert cohorts during an on-the-job learning experience as an outcome of the on-the-job learning assessment exercise through a proficiency evaluation voting system, which extends the review assignment into a group exercise, which further strengthens the value of recommendations. In yet another embodiment, the network of mentors/learners is automatically notified of key learning activities and expectations through an on-line portal that parses and redirect messages from the learning review system. Access to the learning review portal and its voting wizard is also available to mobile devices for ease of use.

In an embodiment, the learning opportunities are generated by the workflow and includes the one or more tasks to be responded by the candidates based on skill level, wherein the learning opportunity matches are determined by matching the one or more tasks of each job against known proficiencies of the work force.

In an embodiment, the job and candidate selection module lists job candidates in order of their proficiency level based on completion results of given tasks from said learning material.

In an embodiment, the system automatically identifies a next step in a job sequence using object recognition, Simultaneous Localization and Mapping (SLAM) and Visual Inertia Odometry (VIO), Global Positioning System (GPS) or an indoor wireless location service or a combination of any, in order to automatically deliver customized job pack components at a specific location for a given task.

In an embodiment, the user is guided to complete the one or more tasks by procedural requirements that includes: reviewing system delivered best practice job/task case studies; abiding by checklist of activities to prepare evidence of completion of work; seeking system administered assistance that enable access to mentor or supervisor when required; and accessing Augmented Reality (AR) and non-AR information at any time during the job life-cycle.

Further features and forms of the present invention will become apparent from the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 illustrates a Correction Notification Alarm and Job Scheduling Poll sub-system according to an embodiment herein; The Correction Notification Alarm and Job Scheduling Poll sub-system utilises the Client Application; Central Processing; Administrator Portal; Data Access API and Data Lake to access and process either Correction Notification Alarm or Jobs pending in a Programmed Job Scheduler system. This sub-system polls for active jobs set up by the job scheduler as well as searches for any alarms that signify corrections to one or more components are required due to a fault. This collection of components collects, filters and priorities structured job notification records and using data mining techniques searches, analyses and visualises machine-generated data gathered from the websites, applications, sensors, IoT mesh, and other non-structured data sources. The information is distilled by processes that apply business rules to prioritise and displays the results in a job notification/alarms notification board accessible by the administrators, or others with appropriate permission;

FIGS. 2A and 2B illustrates a JOB/Candidate Selection mechanism according to an embodiment herein; The JOB/Candidate Selection mechanism utilises Client Application; Central Processing; Machine Learning; ETL; Administrator Portal; Data Access API; Data Lake; GPU Managed Memory Block. The interaction of these system layers, subservient to the afore mentioned purpose, produces a list of job candidates, with and without learning modules and mentors (assigned from cohorts) as per dependency on their system evaluated proficiency, provisioned with customised job packs to meet their individual requirements as per their defined knowledge and skillset. The system is also in charge of notifying and receiving digital communiques from appropriate parties (administrator, cohort and candidates) regarding the job/candidate matching process pursuant to their relevant purposes;

FIG. 3 illustrates a Job Acceptance and Rejection administration module according to an embodiment herein; The Job Acceptance and Rejection administration module access Client Application; Client API; Central Processing; Administrator Portal; Data Access API; Data Lake. The interaction of these system layers, subservient to the afore mentioned purpose, prepares a job proposal package for the candidate to accept or reject. The system collects necessary information from the candidate on rejected submissions, as well as on acceptance, to produce new data that can be used by ML processes to adjust the impacted system profiles, as well as reports that may point at issues or improvements to be made;

FIG. 4 illustrates a Poll User Location mechanism according to an embodiment herein; The Poll User Location mechanism access Client Application; Client API; Central Processing; Data Access API; Data Lake. The interaction of these system layers, subservient to the afore mentioned purpose, is charged with matching the location of the user with the specific task/s that should be performed at such locations. Simultaneous Localization and Mapping (SLAM) and Visual Inertia Odometry may be used by the system to provide a client device with a more accurate sense of the space and user location within it, along with pinpointing critical equipment to which tasks may be attached. The chaining of the job pack, that is which tasks and information appears first, may be sequenced by location detection, object recognition as well as user input, or a combination of all methods;

FIG. 5 illustrates an option to render certain aspects of a job pack as augmented reality experiences, to which a client device provides the activation and rendering service support according to an embodiment herein; This service is supported by a job package preparation service (shown with an off-page indicator) which provides the prepared media and triggers to deliver an Augmented Reality (AR) service, provided a user selects this service;

FIG. 6 illustrates an option to render a job pack without AR support according to an embodiment herein; In this case the job-pack, although still suited to provision AR experiences at key points, restricts its media to non-AR or more traditional delivery modes (forms, documents, photos, etc);

FIG. 7 illustrates an option to activate a Cohort Support System according to an embodiment herein; The option to activate a Cohort Support System is engaged with Client Application; Client API; Central Processing; Administrator Portal; Data Access API; Data Lake. The interaction of these system layers, subservient to the afore mentioned purpose, is charged with administering system registered communication between a novice and their mentor; the mentor's expert opinion on performance by the novice post job completion; and the novice's perception of the selected mentor (as a rapport score). These ratings are serialised for further processing by ML processes;

FIG. 8 illustrates a typical use of a system from the point of view of the novice and cohort according to an embodiment herein; The interaction spans the use of the Client Application; Client API; Central Processing; Administrator Portal and Data Access API. The main features of this interaction includes the system requirements for the novice to use review examples of best practise delivered within the job pack; the requirement of the novice/user to post evidence of job completion, as structures pre-defined by the matter experts (cohort network), such as check-lists with photo/video evidence; diagnostic reports post completion; etc); the cohort two step involvement, with the initial step confirming that a specific mentor has evaluated the job performance of the novice/user and later a committee of the cohort votes on the level of agreement with the initial performance assessment; and finally communication back to the novice/user which might include reports of non-compliance; compliance or compliance with a micro-award, depending on the attributes of the quality of the work completed;

FIG. 9 represents a client user login sequence according to an embodiment herein; The login sub-system relies on the Client Application; Client API; Central Processing; Data Access API and Data Lake;

FIG. 10 represents an administrator login process according to an embodiment herein; The login sub-system relies on the Client Application; Client API; Central Processing; Data Access API and Data Lake;

FIG. 11 illustrates an exploded view of the system according to an embodiment herein; and

FIG. 12 is a flow diagram illustrating a computer implemented method for generating a personalized job workflow, provisioned with machine coordinated learning and skilling pathways discerned by a combination of a machine learning modules (ML) and human intervention according to an embodiment herein.

Preferably, the system issuing a unique client token upon selection of a specific client application which is used to authenticate all Application Programming Interface (application programming interface) calls to the computing platform and ensure that only valid applications are accessing the system.

Preferably, the system comprises a client app configuration page which enables the administrator to select distinct client apps via a client app selection page.

Preferably, selection of a specific client app system elicits the creation of a new computing platform channel and application programming interface application token, the channel being required to isolate records from other client applications.

Preferably, upon authentication of the client application, the client application will download one or more computing platform experience packages that are either not present in a local storage system or have been modified by the content management system portal but not yet downloaded by the client application.

Preferably, an appropriate connection layer to handle external sources of information is selected as a result of the system accessing the specific external data clouds and IoT meshes, wherein the logic layer of the client application contains all the necessary data and client specific application programming interface preparation flows to satisfy the requirements of using the specific service chosen.

Suitably, at least one alert is issued to a user and/or administrator in the event that there is an internet connectivity or downloading issue.

Preferably, at least one request and at least one response issued by the system is in JSON format.

Further features and forms of the present invention will become apparent from the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Skilled addressees will appreciate that elements in the drawings are illustrated for simplicity and clarity and have not necessarily been drawn to precision. For example, the relative relation of some of the elements in the drawings may be simplified to help improve understanding of embodiments of the present invention.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted to increase visibility of the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

However, it will be appreciated that the present invention has broader application and is not limited to that particular use. In this specification, the terms “comprises”, “comprising” or similar terms are intended to mean a non-exclusive inclusion, such that a machine learning assisted workflow planner and job evaluator with learning and micro accreditation pathways comprising a list of elements does not solely include those elements but may well include other elements not listed.

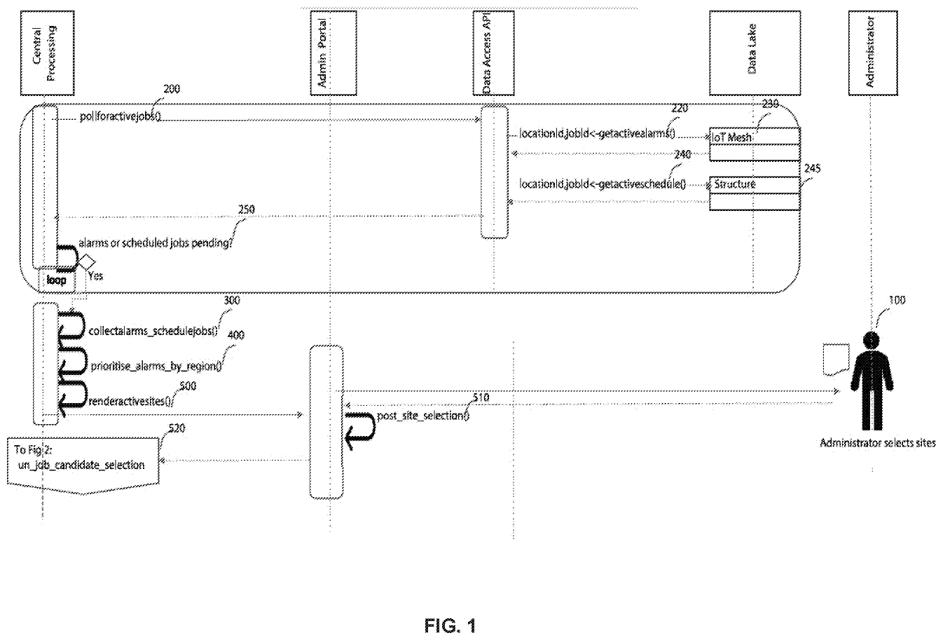

FIG. 1 illustrates a Correction Notification Alarm and Job Scheduling Poll sub-system according to an embodiment herein. The purpose of which is to poll for active jobs set up by the job scheduler and capture any active alarms that signify immediate correction to any part/s of the operational network. This collection of components collects, filters and priorities structured job notification records and using data mining techniques searches, analyses and visualises machine-generated data gathered from the websites, applications, sensors, IoT mesh, and other non-structured data sources. The information is distilled by processes that apply business rules to prioritise and displays the results in a job notification/alarms notification board accessible by the administrators, or others with appropriate permission.

The pollforactivejobs( ) function 200 is a recursive functions, configured to pulse every nth seconds or minutes (the nth seconds or minutes are configurable), that continuously opens and closes non-blocking search threads to locate either active alarms, by launching getactivealarms( ) calls that returns the locationId and jobIDs of any such 220 from the IoT Mesh 230, whilst the getactiveschedule( ) call returns any locationId and jobIDs from records residing in the Structured Data bucket for jobs to be completed nth days from the current date (the nth days is configurable) 245. In cases that active alarms or scheduled jobs are discovered 250, The collectalarms_schedulejobs( ) retrieves and collects the alarms in a list 300 which is used to prioritise_alarms_by_region( ) 400. The renderactivesites( ) displays the available jobs on the Administration Portal 500. The Administrator selects sites 505 that require immediate attention and the system calls post_site_selection( ) 510 in order for the system to run_job_candidate_selection 520.

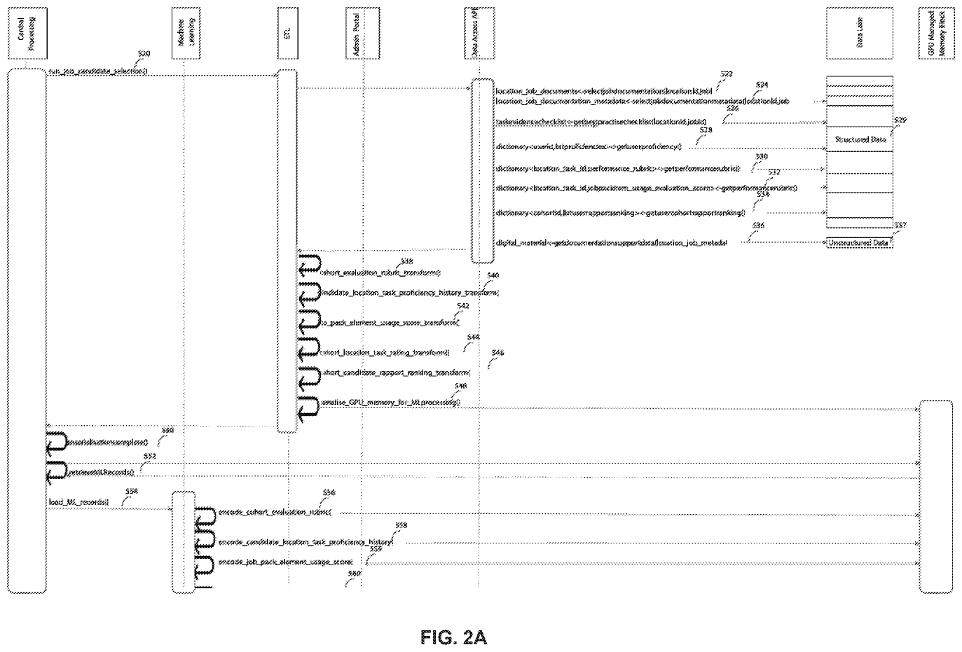

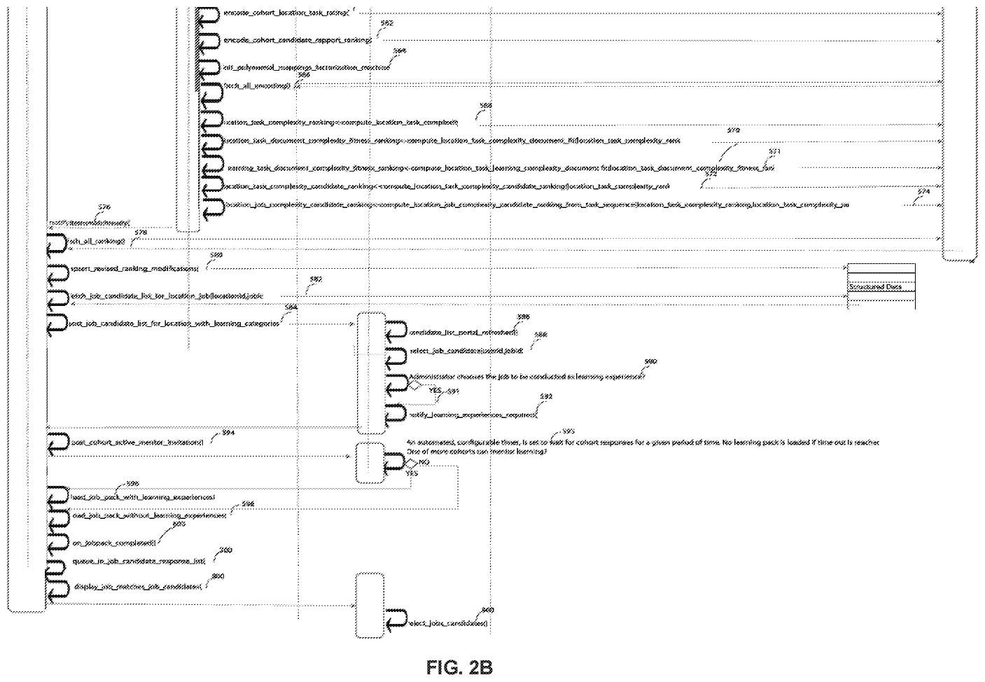

FIGS. 2A and 2B illustrates a JOB/Candidate Selection mechanism according to an embodiment herein. The JOB/Candidate Selection mechanism produces a list of job candidates, with and without learning modules and mentors (assigned from cohorts) as per dependency on their system evaluated proficiency, provisioned with customised job packs to meet their individual requirements as per their defined knowledge and skillset. The system is also in charge of notifying and receiving communiques from appropriate parties (administrator, cohort and candidates) pursuant the job/candidate matching process as relevant to their purposes.

In FIGS. 2A and 2B, method sequences begin by calling the run_job_candidate_selection( ) which coordinates the launch of a set of data access APIs that will cause data transformations at the ETL layer 520, sourced by records residing in the Structured Data segment of the Data Lake 521. These API calls include, selectjobdocumentation(locationId,jobId) requiring locationId and jobId parameters and returning a j son array containing location_job_documents 522; selectjobdocumentationmetadata(locationId,jobId) requiring locationId and jobId parameters and returning a j son array containing location_job_documentation_metadata 524; getbestpractisechecklist(locationId,jobId) requiring locationId and jobId parameters and returning a j son array containing taskevidencechecklist structures 526; getuserproficiency( ) returning a dictionary of userid and listproficiencies value pairs 528; getperformancerubric( ) returning a dictionary of location_task_id and performance_rubric value pairs 530; getperformancerubric( ) returning a dictionary of location_task_id and jobpackitem_usage_evaluation_score value pairs 532; getusercohortrapportranking( ) returning a dictionary of cohortid and listuserrapportranking value pairs 534; getdocumentationsupportdata(location_job_metadata) accepting an argument of type location_job_metadata items (data model array) and returning a dictionary of digital_material urls or storage paths 536, sourced by unstructured data 537 residing in the Data Lake.

In FIGS. 2A and 2B, ETL transformations prepare data for the use ML methods. The data streaming from the Data Access API calls are reshaped appropriately by the following ETL transformations: cohort_evaluation_rubric_transform( ), which holds data to be used by ML transformations to classify elements perceived by the cohort as having an effect on job performance 538; candidate_location_task_proficiency_history_transform( ), which holds data regarding candidates past job performance in relationship to the location and task or tasks performed 540; job_pack_element_usage_score_transform( ), which holds data regarding the usage of elements in a job pack (in terms, of access frequency, average usage time in seconds, usage by candidate proficiency level frequency) 542; cohort_location_task_rating_transform( ) 544, which holds ratings on task complexity calculated by reference to cohort expectations and ML processes at different location and task configurations; cohort_candidate_rapport_ranking_transform( ), which holds ratings of mentors ranked by novices 546; and completes the process by instantiating GPU memory by calling serialise_GPU_memory_for_MLprocessing( ) 548.

In FIGS. 2A and 2B, the Central Processing callback onserialisationcomplete( ) 550 calls retrieveMLRecords( ) 552, to then execute load_ML_records( ) 554 into the ML unit.

In FIGS. 2A and 2B, The ML component then runs methods in sequence, such as, encode_cohort_evaluation_rubric( ), which identifies and classifies any elements perceived by the cohort as having an effect on job performance, both positive and negative 556; encode_candidate_location_task_proficiency_history( ), which rates candidates based on past job performance in relationship to the location and task or tasks performed 558; encode_job_pack_element_usage_score( ), which rates the usage value of elements in a job pack (in terms, of access frequency, average usage time in seconds, usage by candidate proficiency level frequency) 559; encode_cohort_location_task_rating( ), which continuously evaluates the complexity rating for different task configurations at different locations 560; encode_cohort_candidate_rapport_ranking( ), which continuously evaluates the validity of ratings of mentors as ranked by novices 562; init_polynomial_mappings_factorization_machine( ) 564; fetch_all_encoding( ) 566; compute_location_task_complexity( ) which returns a list of location_task_complexity_ranking 568; compute_location_task_complexity_document_fit (location_task_complexity_ranking) which takes a parameter of type location_task_complexity_ranking and returns a list of location_task_document_complexity_fitness_ranking 570; compute_location_task_learning_complexity_document_fit(location_task_document_complexity_fitness_ranking) which takes a parameter of type location_task_document_complexity_fitness_ranking and returns the structure learning_task_document_complexity_fitness_ranking 571; compute_location_task_complexity_candidate_ranking(location_task_complexity_ranking) which takes a parameter of type location_task_complexity_ranking and returns the structure location_task_complexity_candidate_ranking 572; compute_location_job_complexity_candidate_ranking_from_task_sequence(location_task_complexity_ranking,location_task_complexity_ranking) which takes parameters of type location_task_complexity_ranking and location_task_complexity_ranking and returns the structure location_job_complexity_candidate_ranking 574;

In FIGS. 2A and 2B, the callback onMLRecordsProcessedOK( ) 576 instigates the call fech_all_ranking( ) 578 which stores results in the GPU Managed Memory Block. The Central Processing unit then calls upsert_revised_ranking_modifications( ) 580; followed by fetch_job_candidate_list_for_location_job(locationid,jobid) which accepts parameters locationid and jobid and loads the ranking modifications into a temporary memory buffer 582 prior to calling post_job_candidate_list_for_location_with_learning_categories( ) 584.

In FIGS. 2A and 2B, the Administration Portal is refreshed followed the call candidate_list_portal_refreshed( ) 586, which prompts the function select_job_candidate(userid,jobid), accepting userid and jobid as parameters, to display the appropriate job and potential job candidate list 588. If the administrator finds and selects a job that has the potential to be conducted as learning experience 590, the system executes notify_learning_experiences_required( ) 592 which launches, post_cohort_active_mentor_invitation( ) 594, an automated, timed service set to wait for cohort responses for the pre-configured period of time with the consequence of no learning pack being loaded if a response time out is reached. If one of more cohorts respond to accept the role of mentor for such instance of learning 595, the load_job_pack_with_learning_experiences( ) is activated, resulting in the inclusion of learning material being injected into the job pack 596. An administrator choice not to include a learning experience with the job pack executes load_job_pack_without_learning_experiences( ) 598. The callback on_jobpack_completed( ) 600 issues the call to queue_in_job_candidate_response_list( ) which is a list of all potential job and job candidates, issued with or without a learning experience as per Administrator requirements 700. The job/job candidate list is rendered by the display_job_matches_job_candidates( ) call 800. The administrator then selects the job/candidate pairs with assistance from the function select_jobs_candidates( ) 900.

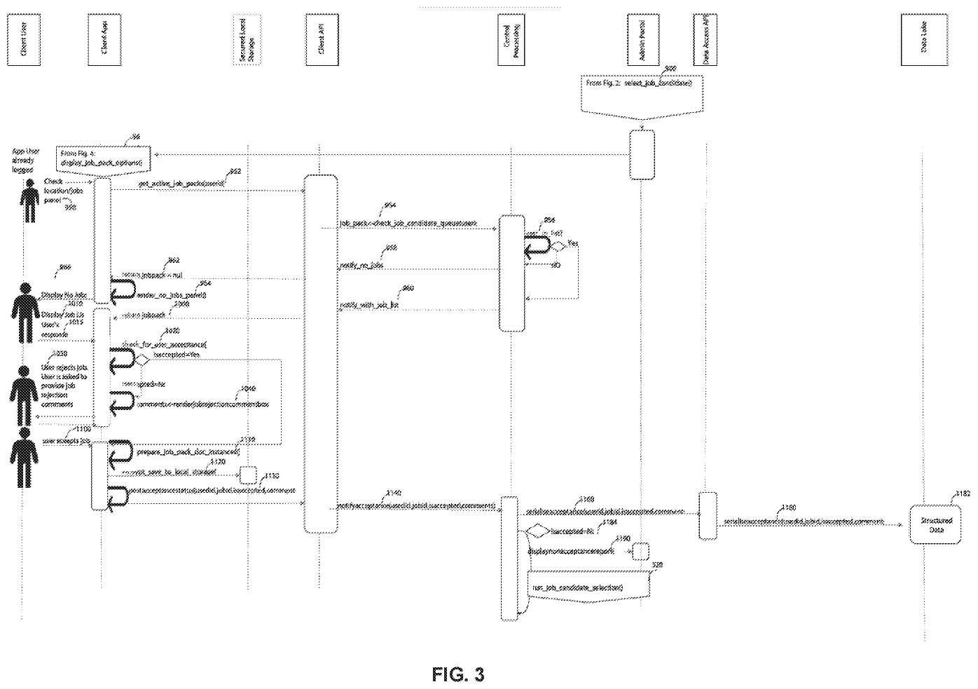

FIG. 3 illustrates a Job Acceptance and Rejection administration module according to an embodiment herein. The Job Acceptance and Rejection interactions which prepares job proposal packages for candidates to accept or reject. The system collects necessary information from the candidate on rejected submissions, as well as on acceptance, to produce new data that can be used by ML processes to adjust the impacted system profiles, as well as reports that may point at issues or improvements to be made.

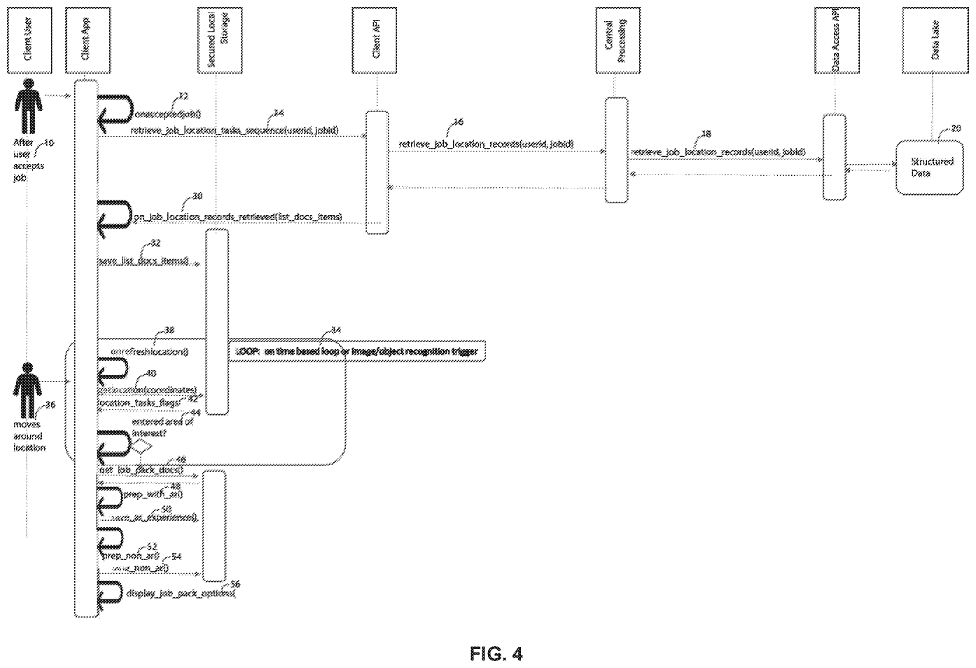

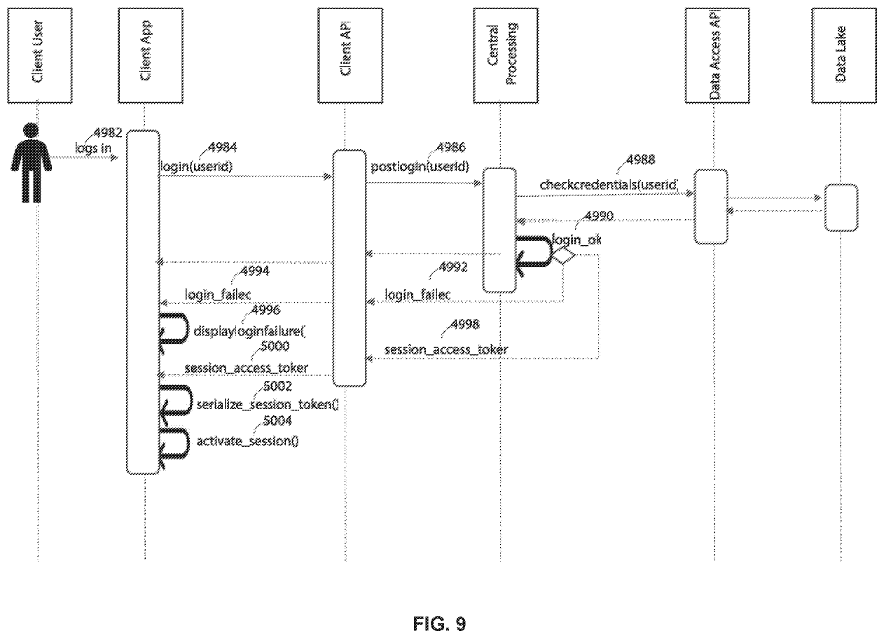

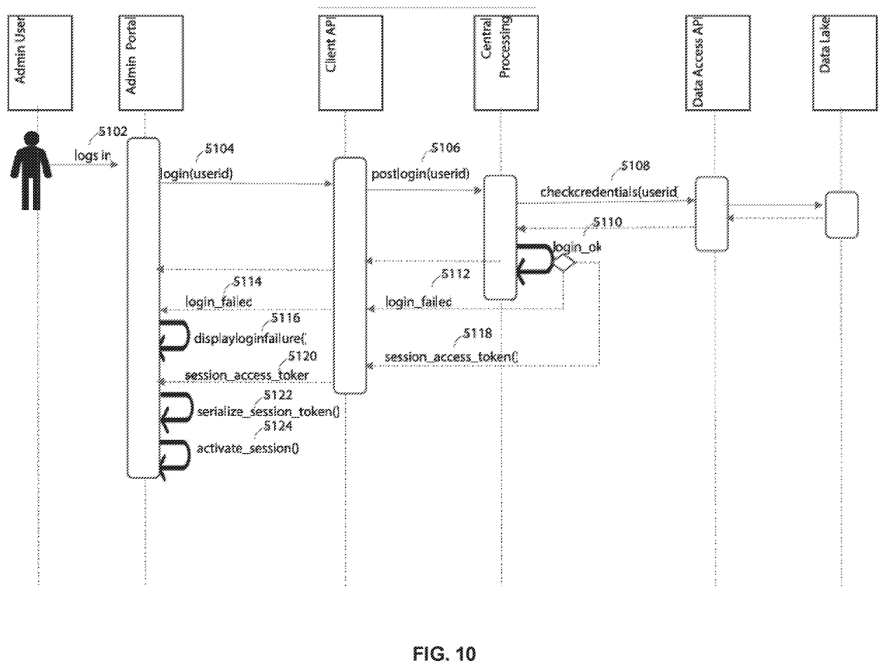

In FIG. 3, select_job_candidate( ) 900 and display_jobpack_options( ) 56 refers to off-page processes (FIG. 4) stipulating that those callouts have already occurred. At this stage an App user is already logged into the system and would have received a session token from the system, which would be used to entitle the client app to fully utilise the client API. From here on, although userid and session token are technically different, this distinction is not pertinent to elucidating any part of this document. To simplifying explanations, we refer to the session token as the userid, which is understood to be created and resolved into a userid by mechanisms described in FIG. 9 and FIG. 10.

In FIG. 3, the user is interposed checking location and jobs panel 950 refreshed by the call get_active_jobpacks(userid) which requires the userid as a parameter 952. This call launches the check_job_candidate_queue(userid) API, also requiring the userid as the parameter 954. If the user is not found in the job and candidate queue 956, the user is notified by notify_no_jobs( ) 958 which returns no jobpack 962 and presents the job/candidate with a render_no_jobs_panel( ) 964, which displays a form of “no available jobs” message 966. Should the user find their name in the client app Job List window 1010, they are free to accept or reject the job 1015. The function check_for_user_acceptance( ) 1020 inputs the user's decision into the system. Should the user reject the job, or jobs, they are prompted by the system to choose a best fit from any variety of reasons that would negate the possibility of commencing that type of job, as well as, providing free text job rejection comments 1030. This information is collected by the renderjobrejectioncommentbox( ) 1040. Should the user accept the job 1100, job documentation is collated by prepare_job_pack_doc_instances( ) 1110. The jobpack is encrypted and saved into local storage by the function encrypt_save_to_local_storage( ) 1120. The user's response to the job proposal is further processed by a sequence of calls and functions, such as, postacceptancestatus(usedid, jobid,hasaccepted,comments), which takes usedid, jobid, hasaccepted and comments as parameters 1130; notifyacceptance(usedidjobid,hasaccepted,comments) which takes usedid, jobid, hasaccepted and comments as parameters 1140; serialiseacceptance(userid,jobid, hasaccepted,comments) which takes usedid, jobid, hasaccepted and comments as parameters 1160; serialiseacceptance(usedidjobid,hasaccepted,comments) which takes usedid, jobid, hasaccepted and comments as parameters 1180 and saves this record within the “Structured Data” segment in the Data Lake 1182. If the user did not accept the job proposal 1184, the displaynonacceptancereport( ) provides the view into the rejection rationale 1190. To complete the cycle, the offpage (FIG. 2) run_job_candidate_selection( ) 520 cycle is run again to reselect new candidates for the rejected job.

A system for generating automatic workflows, provisioning learning and skilling pathways based on dynamically evaluating the proficiency level of practitioners of any skill set, and producing specific documentation and job information supported by Machine Learning (ML) methodologies and human interaction, extending to the integration of IoT and the mining of unstructured data networks to efficiently address the requirements of job outcomes.

FIG. 4 illustrates a Poll User Location mechanism according to an embodiment herein. The sub-system that Polls for User Location, which is charged with matching the location of the user with the specific task/s that should be performed at such locations. Simultaneous Localization and Mapping (SLAM) and Visual Inertia Odometry (VIO) may be used by the system to provide the client device with a more accurate sense of the space and user location within it, along with pinpointing critical equipment to which tasks may be attached. The chaining of the job pack, that is which tasks and information appears first, may be sequenced by location detection, object recognition as well as user input, or a combination of all methods.

In FIG. 4, after the user accepts a job, or jobs, 10 the callback onacceptedjob( ) 12 is instigated launching the client app call get_job_location_records(userid, jobid), which requires userid and jobid parameters 14, and resolves into a client API call to the Central Processing unit to retrieve_job_location_records(userid,jobid) passing on the previous parameters 16 to prepare_job_location_records(userid, jobid) to access the necessary records 18 within the Structured Data segment in the Data Lake 20. The client app callback on_job_location_records_retrieved(list_docs_items), which requires a list_docs_item structure, as a by reference parameter or out parameter, 30 to use when calling the save_list_docs_items( ) function 32.

FIG. 4 details a recursive, either on-time based loop or an image/object recognition activation cycle, or a combination of both working in tandem, 34, that tracks the movement of the user around a location 36. The call onrefreshlocation( ) act as very granular selector of user coordinates, as it measures the users relative position to an object or piece of equipment that has a task that requires completion (as part of the corrective or maintenance component of the job requirement) 38. The getlocation(coordinates) requires coordinates that may or may not include vector values measuring depth, depending on the implementation of the location service 40. The location_tasks_flags 42 which includes as a minimum the effect of “entered area of interest”, but may also include “exited area of interest” or “tracked specific object” 44, ensure that the appropriate element is selected by the get_job_pack_does( ) function 46, which would provide specific task based information for specific knowledge/skill levels depending on the user proficiency level. The prep_with_ar( ) 48 and save_ar_experience( ) 50 calls are only valid when users select AR assistance, for other instances prep_non_ar( ) 52 and save_non_ar( ) 54 would be used. Regardless of the option selected by users the selected calls result in preparing and saving the material accordingly so that the jobpacks display_job_pack_options( ) 56 can provision the appropriate experiences as selected by the user.

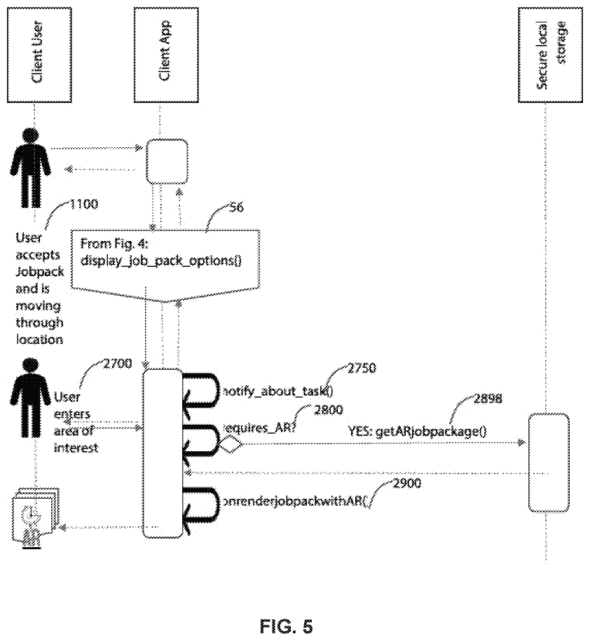

FIG. 5 illustrates an option to render certain aspects of a job pack as augmented reality experiences, to which a client device provides the activation and rendering service support according to an embodiment herein. This service is supported by the job package preparation service (shown with a FIG. 4 off-page indicator) which provisions the prepared media and triggers to deliver the AR service 56, provided the user selects this service 1100. When the user enters an area of interest 2700 the user is notified about the job/task that needs performing by the notify_about_task( ) function 2750. Should the user require AR assistance 2800 then the system delivers the job package with AR support by relying on the getARjobpackage( ) 2898 and onrenderjobpackwithAR( ) 2900 functions.

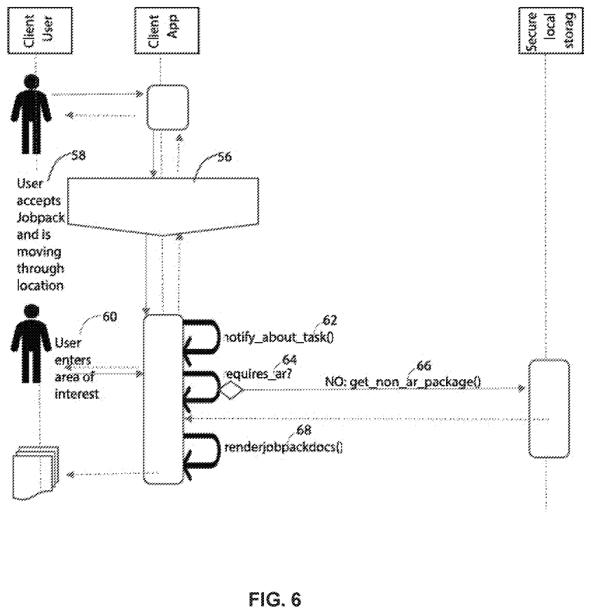

FIG. 6 illustrates an option to render the job pack without AR support according to an embodiment herein. In this case the job-pack, although still suited to provision AR experiences at key points, restricts its media to non-AR or more traditional delivery modes (forms, documents, photos, etc). This service is supported by the job package preparation service (shown with a FIG. 4 off-page indicator) which provisions the prepared media and triggers with a non-AR option 56. Once the user accepts the job pack and moves through the site 58 and enters an area of interest 60 the user is notified about the job/task that needs performing by the notify_about_task( ) function 62. Should the user not require AR assistance 64 then the system delivers the job package without AR support by relying on the get_non_arpackage( ) 66 and renderjobpackdocs( ) 68 functions.

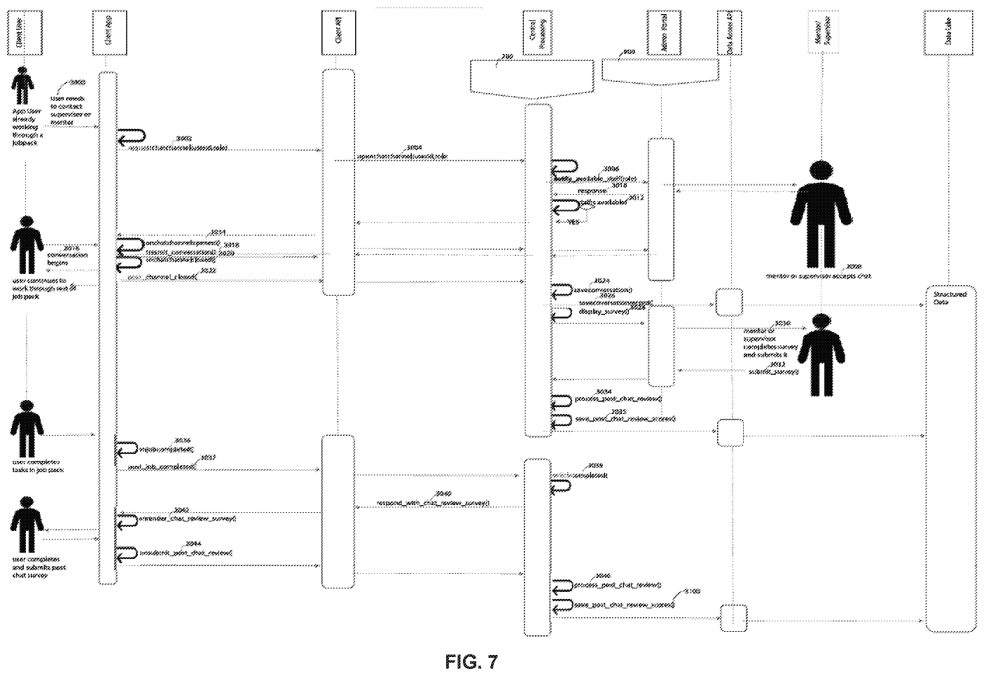

FIG. 7 illustrates an option to activate a Cohort Support System according to an embodiment herein. The FIG. 7 charged with administering system registered communication between a novice and their mentor; the mentor's expert opinion on performance by the novice post job completion; and the novice's perception of the selected mentor (as a rapport score). These ratings are serialised for further processing by ML processes. This service is supported by the queue_in_job_candidate_response_list( ) 700 and select_job_candidate( ) 900 functions (shown with a FIG. 2 off-page indicator).

In FIG. 7, the user is interposed already working through a jobpack 2998 and in need of contacting a supervisor or mentor 3000. By using a communications option in their app the user activates the requestchatchannel(userid,role) function, which requires their already known userid and role as parameters 3002. This event engages the client API openchatchannel(userid,role) which reuses the posted parameters 3004.

In FIG. 7, the Central processing layer handshakes with the openchatchannel request and launches the notify_available_staff( ) 3006 function which posts a network wide notification to all users listed as mentors for the specific knowledge/skill set required to complete the job in question. The system requests listed mentor/s and/or the appropriate supervisor to accept the invitation to assist using the private chat service 3008. If the response 3010 confirms one or more available staff 3012, a direct chat line between the novice and the mentor is opened by onchatchannelopened( ) 3014. The trasmit_conversation( ) 3018 service is active until the users close their conversation onchatchannelclosed( ) 3020 and then the post_channel_closed( ) 3022 activates saveconversation( ) 3024, which triggers the savecoversationrecord( ) function, with full voice recording as well as Voice-to-Text services 3026, to serialise any other digital materials that might have been used as instructional or informational aids. The display_survey( ) 3028 instructs the mentor to complete a performance survey on the novice, which is submitted by the mentor or supervisor 3030 by activating the submit_survey( ) 3032 function. Likewise, on the client app side, the render_user_mentor_review_survey( ) 3033 method prompts the user to complete and submit the mentor review survey 3034. The user submits the completed survey, which is meant to measure perceptions on understanding support requirements; mentor's communication skills; mentor's training/information dissemination approach; and a set of questions to discern the rapport level between the novice and the mentor, post_user_mentor_review_survey( ) 3035. There is a cycle of processing by the central processing layer process_post_chat_review( ) 3036, which takes survey structured field responses, including rating and scores, and free text commentaries, and serialises the appropriate results using save_post_chat_review_scores( ) 3038.

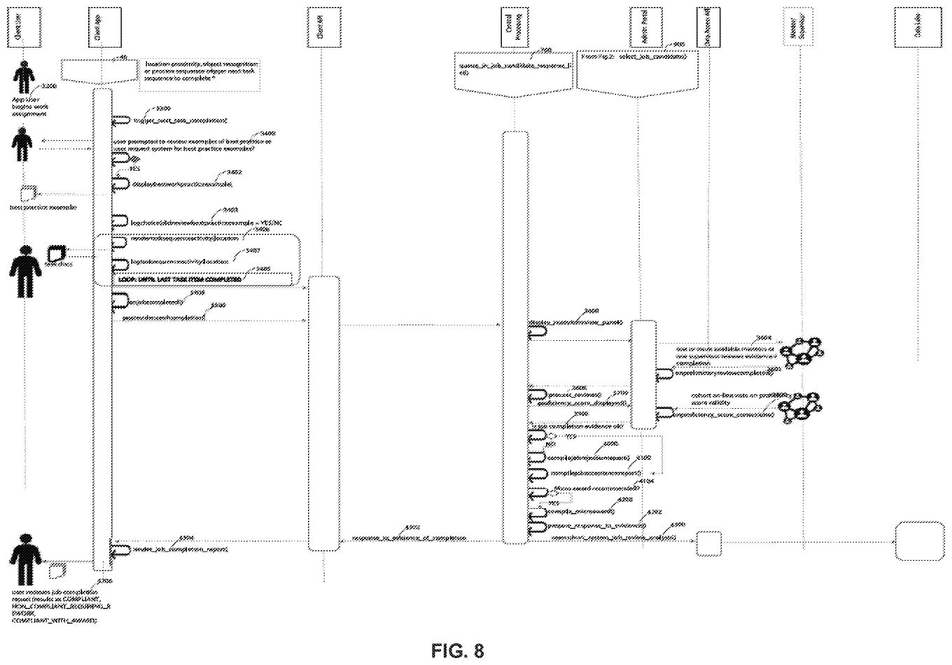

FIG. 8 illustrates a typical use of the system from the point of view of the novice and cohort according to an embodiment herein. The interaction spans the use of the Client Application; Client API; Central Processing; Administrator Portal and Data Access API. The main features of this interaction includes the system requirements for the novice to use review examples of best practise delivered within the job pack; the requirement of the novice/user to post evidence of job completion, as structures pre-defined by the matter experts (cohort network), such as check-lists with photo/video evidence; diagnostic reports post completion; etc); the cohort two step involvement, with the initial step confirming that a specific mentor has evaluated the job performance of the novice/user and later a committee of the cohort votes on the level of agreement with the initial performance assessment; and finally communication back to the novice/user which might include reports of non-compliance; compliance or compliance with a micro-award, depending on the attributes of the quality of the work completed.

FIG. 8 refers to three off-page diagrams, FIG. 4: get_job_pack_docs( ) 046; FIG. 2: queue_in_job_candidate_response_list( ) 700; and select_job_candidate( ) 900. These services provide the necessary mechanism to have selected the appropriate job candidates and job support resources that will also be provisioned with location proximity, object recognition or process sequences that trigger prompts to carry out the next task in a job sequence (with or without AR assistance dependent on the already selected method by the user). The user is assumed to be logged in by this stage and commencing their work assignment 3200. The trigger_next_task_completion( ) 3300 is a software hook attached to one, or all, the possible environmental triggers available (object recognition, GPS/Wi-fi Proximity notification, SLAM, VIO, or procedural) depending on the configuration of the app (i.e. what system/s was/were selected when the app is initialised), that can recognise at which point a new task, and pertinent information should be presented to the user. At the beginning of a new task sequence the user is prompted to review examples of best practice or the user can request the system to provide samples of best practice at any time 3400. Once the user reviews the example 3402 (or fails to review it) the action is logged by the function logchoice(didreviewbestpracticeexample), where the parameter didreviewbestpractice example is a Boolean representing YES or NO 3403. The system launches a side thread that enters a non-blocking loop until the last task item is completed within the jobpack heriarchy 3405. The function rendertasksequenceactivity(location), requires a location coordinate that may or may not include vector values measuring depth, depending on the implementation of the location service 3406 and creates and displays all the documentation items that may be required by the user to complete the specified task. The logtasksequenceactivity(location) 3407, using the same parameter definitions previously applied, serialises all activities related to: completing the task; evidencing the performance of the work; any support structures or actions that assisted the user in completing the task (if any).

In FIG. 8, once the user claims completion of all tasks related to the job pack in question, they submit the work as completed, onjobcompleted( ) 3408, which packages all evidence of completion through the client app, launching the postevidenceofcompletion( ) 3500 call.

In FIG. 8, the Central process layer executes display_readyforreview_panel( ) 3600, for one or more available mentors, and at least one supervisor, to review the evidence of completion 3604. There is a preliminary review by one supervisor/mentor that produces a performance score on the work quality/quantity, along with free text commentary to support the decision captured by onpreliminaryreviewcompleted( ) 3605. The function process_reviews( ) 3606 supports proficiency_score_displayed( ) 3700, in order to present the cohort an on-line forum in which to vote on the validity of the work proficiency score supplied 3800. Any corrections by the cohort are handled by the onproficiency_score_corrections( ), after which there is a group decision on whether the job completion evidence meets standards, and whether the user has met those standards in reference to the evidence they presented 3900. If the user is deemed as not having met work performance standards the function compilejobrejectionreport( ) 4000 automatically creates a job rejection report, which compiles the group's evidence for failing the performance. In better circumstances a compilejobacceptancereport( ) is completed to signal acceptance of the work carried out 4100. The system may recommend presenting the novice with a Micro award or accreditation, that is an accreditation that is at least acceptable to the enterprise provisioning them, to evidence specific learning or skills in a specific area, for the purpose of further training and/or career advancement 4104. If the micro award is acceptable then the compile_microaward( ) 4200 creates a digital representation of the award, listing the type and level of proficiency gained by the novice. The prepare_response_to_evidence( ) 4202 function will include the micro award, if such has been prepared, into the final job completion report that will be presented to the user or novice. The savecohort_system_job_review_analysis( ) 4300 saves the group analysis and the response_to_evidence_of_completion 4302 prepares the group summations used by the render_job_completion_report( ) 4304. The user receives a job completion report with results that may refer to meeting compliance; non-compliant and requiring rework; or meeting compliance with award 4306.

FIG. 9 and FIG. 10 are representations of the interaction of sub-systems that manage the login process, FIG. 9 referencing the client user login sequence; whilst FIG. 10 refers to the administrator login process. The login sub-system relies on the Client Application; Client API; Central Processing; Data Access API and Data Lake. The login implementation bears no impact on the system hereby described (other than to support the notion of a secured environment) and hence requires no further explanations.

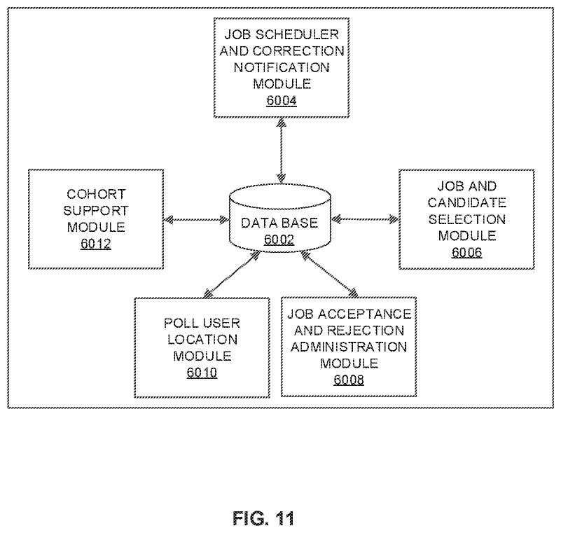

FIG. 11 illustrates an exploded view of the system according to an embodiment herein. The exploded view includes a database 6002, a job scheduler and correction notification module 6004, a job and candidate selection module 6006, a job acceptance and rejection administration module 6008, a poll user location module 6010 and a a cohort support module 6012. The job scheduler and correction notification module 6004 collects the region or location data pertinent to the job workflow planning requirements based on the data mining and the machine learning (ML) process. The job scheduler and correction notification module 6004 further surveys for active jobs setup by the job scheduler. The job scheduler and correction notification module 6004 searching for the alarm notification that signify corrections of one or more components of the region or location data. The job scheduler and correction notification module 6004 collects, filters and priorities job notifications based on predefined rules and displays the job notification results in a job/alarms notification tab that is accessible by a user.

The job and candidate selection module 6006 provides the list of job candidates with mentors based on proficiency evaluated for each candidates by the system. The list of job candidates are provided with customized job packs to meet their individual requirements based on their defined knowledge and skillset. The job or candidate selection module 6006 receives and notifies one or more digital communications from one or more users about a job and candidate matching process. The job acceptance and rejection administration module 6008 prepares a job proposal package for a candidate to accept or reject. The job acceptance and rejection administration module 6008 collects one or more information from the candidate on submission of both rejection and acceptance. The job acceptance and rejection administration module 6008 adjust the candidate profile through the ML processes based on the information obtained from the candidate.

The poll user location module 6010 matches a location of the candidate with one or more tasks that should be performed at the location. The poll user location module 6010 identifies the accurate location of the candidate and sense of a space using Simultaneous Localization and Mapping (SLAM) and Visual Inertia Odometry (VIO) along with pinpointing critical equipment to which tasks will be attached. The chaining of the job pack, that is which task and information to be appear first is scheduled based on at least one of location detection, object recognition and user input. The cohort support module 6012 enables communication between the candidate who is novice and his/her mentor. The cohort support module 6012 provides expert opinion on performance of the candidate on post job completion or the one or more tasks performed by the candidate for a specific job or the location.

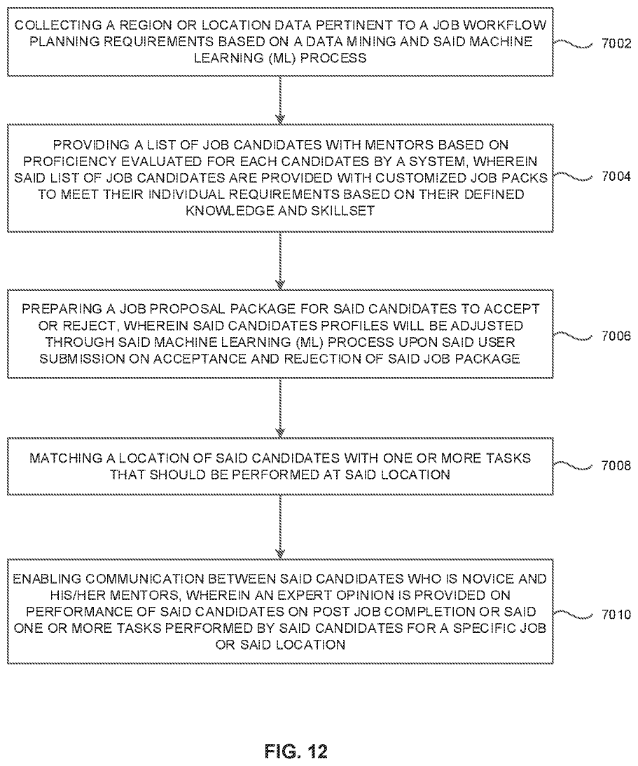

FIG. 12 is a flow diagram illustrating a computer implemented method for generating a personalized job workflow, provisioned with machine coordinated learning and skilling pathways discerned by a combination of a machine learning modules (ML) and human intervention according to an embodiment herein. In step 7002, the job scheduler and correction notification module 6004 collects the region or location data pertinent to the job workflow planning requirements based on the data mining and the machine learning (ML) process. In step 7004, the job and candidate selection module 6006 provides the list of job candidates with mentors based on proficiency evaluated for each candidates by the system. in step 7006, the job acceptance and rejection administration module 6008 prepares a job proposal package for a candidate to accept or reject. In step 7008, the poll user location module 6010 matches a location of the candidate with one or more tasks that should be performed at the location. In step 7010, the cohort support module 6012 enables communication between the candidate who is novice and his/her mentor.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

What is claimed is:

1. A system for generating a personalized job workflow, provisioned with machine coordinated learning and skilling pathways discerned by a combination of a machine learning modules (ML) and human intervention, comprising:
a job scheduler and correction notification module that collects a region or location data pertinent to a job workflow planning requirements based on a data mining and said machine learning (ML) process, wherein said job scheduler and correction notification module surveys for active jobs setup by a job scheduler, wherein said job scheduler and correction notification module searching for an alarm notification that signify corrections of one or more components of said region or location data, wherein said job scheduler and correction notification module collects, filters and priorities job notifications based on predefined rules and displays said job notification results in a job/alarms notification tab that is accessible by a user;
a job and candidate selection module that provides a list of job candidates with mentors based on proficiency evaluated for each candidates by said system, wherein said list of job candidates are provided with customized job packs to meet their individual requirements based on their defined knowledge and skillset, wherein said job or candidate selection module receives and notifies one or more digital communications from one or more users about a job and candidate matching process.
a job acceptance and rejection administration module prepares a job proposal package for a candidate to accept or reject, wherein said job acceptance and rejection administration module collects one or more information from said candidate on submission of both rejection and acceptance, wherein said job acceptance and rejection administration module adjust said candidate profile through said ML processes based on said information obtained from said candidate;
a poll user location module matches a location of said candidate with one or more tasks that should be performed at said location, wherein said poll user location module identifies said accurate location of said candidate and sense of a space using Simultaneous Localization and Mapping (SLAM) and Visual Inertia Odometry (VIO) along with pinpointing critical equipment to which tasks will be attached, wherein chaining of said job pack, that is which task and information to be appear first is scheduled based on at least one of location detection, object recognition and user input; and
a cohort support module enables communication between said candidate who is novice and his/her mentor, wherein said cohort support module provides expert opinion on performance of said candidate on post job completion or said one or more tasks performed by said candidate for a specific job or said location.

2. The system of claim 1, wherein the system comprises a cloud storage unit, also referenced as a data lake, that comprises workflow documentations, learning materials, photos and videos with metadata that are relevant to learning materials and any other digital materials.

3. The system of claim 1, wherein the data mining algorithm and ML process determines a level of expertise of cohorts, including their rapport with novices, in a given network, wherein the cohort is nominated by said system as including specific individuals with areas of expertise to which new learners can subscribe through said system network.

4. The system of claim 1, wherein said system comprises a system managed learning review mechanism to support and evidence learning on said job, wherein said system managed learning review mechanism utilises a network of assigned mentors, previously recommended by said system and conferred as mentors by said candidate for scheduling automated notifications related to key processes, activities, and learning milestones that should be completed by said candidate, wherein said system managed learning review mechanism injects a dictionary of administrator designed sentences that marshal the notification process to produce sufficiently clear instructions to each group comprises said mentors and said candidates about activities that must be carried out by said mentors and candidates to complete said learning review process.

5. The system of claim 1, wherein the system receives feedback from expert cohorts during an on-the-job learning experience as an outcome of the on-the-job learning assessment exercise through a proficiency evaluation voting system, which extends review assignment into a group exercise, which strengthens the value of recommendations.

6. The system of claim 1, wherein learning opportunities are generated by said workflow and comprises said one or more tasks to be responded by said candidates based on skill level, wherein said learning opportunity matches are determined by matching said one or more tasks of each job against known proficiencies of a work force.

7. The system of claim 1, wherein said job and candidate selection module lists job candidates in order of their proficiency level based on completion of given tasks from said learning material.

8. The system of claim 1, wherein said system automatically identifies a next step in a job sequence using object recognition, said Simultaneous Localization and Mapping (SLAM) and said Visual Inertia Odometry (VIO), Global Positioning System (GPS) or an indoor wireless location service or a combination of any, in order to automatically deliver customized job pack components at a specific location.

9. The system of claim 1, wherein said user is guided to complete said one or more tasks by procedural requirements that comprises: reviewing system delivered best practice job/task case studies; abiding by checklist of activities to prepare evidence of completion of work; seeking system administered assistance that enable access to mentor or supervisor when required; and accessing Augmented Reality (AR) and non-AR information at any time during job progress.

10. A method for generating a personalized job workflow, provisioned with machine coordinated learning and skilling pathways discerned by a combination of a machine learning modules (ML) and human intervention, comprising:
Collecting a region or location data pertinent to a job workflow planning requirements based on a data mining and said machine learning (ML) process;
providing a list of job candidates with mentors based on proficiency evaluated for each candidates by a system, wherein said list of job candidates are provided with customized job packs to meet their individual requirements based on their defined knowledge and skillset;
preparing a job proposal package for said candidates to accept or reject, wherein said candidates profiles will be adjusted through said machine learning (ML) process upon said user submission on acceptance and rejection of said job package;
matching a location of said candidates with one or more tasks that should be performed at said location; and
enabling communication between said candidates who is novice and his/her mentors, wherein an expert opinion is provided on performance of said candidates on post job completion or said one or more tasks performed by said candidates for a specific job or said location.
